(19) United States
(12) Patent Application Publication
(10) Pub. No.: US 2015/0365964 A1
(43) Pub. Date: Dec. 17, 2015

(54) METHOD OF AND APPARATUS FOR DETERMINING ECCE SEARCH SPACE OF EPDCCH FOR CROSS CARRIER SCHEDULING

(71) Applicant: ALCATEL LUCENT, Boulogne Billancourt (FR)

(72) Inventors: Qi Jiang, Shanghai (CN); Zheng Liu, Shanghai (CN)

(73) Assignee: ALCATEL LUCENT, Boulogne Billancourt (FR)

(21) Appl. No.: 14/761,449

(22) PCT Filed: Jan. 13, 2014
(86) PCT No.: PCT/IB2014/000111

§ 371 Date: Jul. 16, 2015

(30) Foreign Application Priority Data
Jan. 16, 2013 (CN) 201310015323.3

(51) Int. Cl. H04W 72/12; H04L 5/00

(52) U.S. Cl. CPC H04W 72/1263; H04L 5/001

(57) ABSTRACT

The invention provides a method of and apparatus for determining an ECCE user equipment specific search space of an EPDCCH for cross carrier scheduling. According to an embodiment of the invention, the method includes: determining a distance between candidates of a search space at each aggregation level at least according to total number N_{CI} of carriers that can be scheduled concurrently and a carrier indicator n_{CI}, wherein the carrier indicator n_{CI} indicates respective carriers among the N_{CI} carriers that can be scheduled concurrently; and determining positions, of the candidates of the search space at each aggregation level, in allocated ECCEs at least according to the determined distance. According to the invention, in the situation of cross carrier scheduling, candidates of a search space at each aggregation level can be positioned uniformly in allocated ECCEs, and for a single user equipment, control information over a carrier corresponding to data over different carriers can be spaced apart and use different candidates.

### FIELD OF THE INVENTION

The present disclosure relates to a communication system and particularly to a method of and apparatus for determining an ECCE user equipment specific search space of an EPDCCH for cross carrier scheduling.

### BACKGROUND OF THE INVENTION

In Release 11 of LTE-Advanced, a new control channel, which is an Enhanced Physical Downlink Control Channel (EPDCCH), is determined to be transmitted in one or more Physical Resource Block (PRB) pairs in a subframe. Each PRB pair is a block of resource including a time-domain resource occupied by a half timeslot in a subframe, that is, 7 OFDM symbols, and a frequency-domain resource occupied by 12 subcarriers, totaling to 180 kHz with 15 KHz per subcarrier. A PRB pair includes two PRBs in two timeslots in a subframe.

An EPDCCH is consisted at the granularity of an Enhanced Control Channel Element (ECCE) as a resource unit. An ECCE can be consisted of a plurality of (e.g., 4 or 8) Enhanced Resource Element Groups (EREGs). A PRB pair includes 16 EREGs.

An EPDCCH can be transmitted in a localized or distributed manner. With localized transmission, an ECCE is mapped to an EREG of the same PRB pair. With distributed transmission, an ECCE is mapped to an EREG of different PRB pairs. With localized transmission, a multi-user gain can be obtained through frequency-domain scheduling. With distributed transmission, a frequency diversity gain can be obtained.

According to different aggregation level, an EPDCCH can include one or more ECCEs at a different aggregation level including 1, 2, 4, 8 and 16, that is, the EPDCCH can be consisted of 1 ECCE, 2 ECCEs, 4 ECCEs, 8 ECCEs or 16 ECCEs.

There are a corresponding number of candidates, i.e., the largest number of blind detections in the same Downlink Control Indicator (DCI) format, at a different ECCE aggregation level. For example, in a user equipment specific search space, there are 8 candidates at the aggregation level 1, 4 candidates at the aggregation level 2, 2 candidates at the aggregation level 4, and 1 candidate at the aggregation level 8.

IN RANI #71, with localized transmission, a user equipment specific search space of an EPDCCH for a User Equipment (UE) is determined in the formula of:

$$L \{ ( {Y}_{k} + ⌊ \frac{m \cdot {N}_{ECCE , k}}{L \cdot {M}_{set}^{( L )}} ⌋ ) mod ⌊ {N}_{ECCE , k} / L ⌋ \} + i \qquad ( Formula 1 )$$

With distributed transmission, a user equipment specific search space of an EPDCCH for a User Equipment (UE) is determined in the formula of:

L{(Yₖ+m)mod └N_{ECCE,k}/L┘}+i (Formula 2)

In both of the formulas above, L represents the aggregation level, N_{ECCE,k} represents a total number of available ECCEs configured in a k-th sub-frame for the user equipment, Mₛₑₜ^{(L)} represents a total number of candidates in a search space at the L-th aggregation level, m=0, . . . , Mₛₑₜ^{(L)}−1, represents a sequence number among the Mₛₑₜ^{(L)} candidates, Yₖ represents a hash function based upon a frame k and an RNTI of the user equipment, and i=0, 1, 2 . . . L−1 represents a sequence number of an ECCE at each aggregation level.

It is currently desirable to address the problem of how to introduce a carrier indicator n_{CI} to both of the formulas above with respect to an EPDCCH in the situation of cross carrier scheduling where data over a plurality of carriers can be scheduled by control information over one carrier. Here the carrier indicator n_{CI} indicates respective carriers among N_{CI} carriers that can be scheduled concurrently.

An intuitive solution to the problem above is to have the carrier indicator n_{CI} introduced directly to Formula 1 and Formula 2 to thereby derive Formula 3 for localized transmission and Formula 4 for distributed transmission respectively:

$$\begin{matrix}L \{ ( {Y}_{k} + ⌊ \frac{( m + {M}_{set}^{( L )} \cdot {n}_{CI} ) \cdot {N}_{ECCE , k}}{L \cdot {M}_{set}^{( L )}} ⌋ ) mod ⌊ {N}_{ECCE , k} / L ⌋ \} + i & ( Formula 3 ) \\ L \{ ( {Y}_{k} + m + {M}_{set}^{( L )} \cdot {n}_{CI} ) mod ⌊ {N}_{ECCE , k} / L ⌋ \} + i & ( Formula 4 )\end{matrix}$$

However, from Formula 3, the newly introduced carrier indicator n_{CI} has no influence upon a distribution of candidates at the respective aggregation levels, which conflicts with the original intention for introduction of the carrier indicator n_{CI} to Formula 1.

### SUMMARY OF THE INVENTION

In view of the foregoing problem in the prior art, an object of the invention is to provide a method of determining an ECCE user equipment specific search space of an EPDCCH for cross carrier scheduling under localized transmission. In this method, in the situation of cross carrier scheduling, candidates of a search space at each aggregation level can be positioned uniformly in allocated ECCEs (that is, all the ECCEs of the candidates can be distributed uniformly among allocated Physical Resource Block (PRB) pairs), and for a user equipment, control information over a carrier corresponding to data over different carriers can be spaced apart and use different candidates.

According to a first aspect, there is proposed a method of determining an ECCE user equipment specific search space of an EPDCCH for cross carrier scheduling, the method including the steps of: A. determining a distance between candidates of a search space at each aggregation level at least according to total number N_{CI} of carriers that can be scheduled concurrently and a carrier indicator n_{CI}, wherein the carrier indicator n_{CI} indicates respective carriers among the N_{CI} carriers that can be scheduled concurrently; and B. determining positions, of the candidates of the search space at each aggregation level, in allocated ECCEs at least according to the determined distance.

According to a second aspect, there is proposed a method determining an ECCE user equipment specific search space of an EPDCCH for cross carrier scheduling, the method including the steps of: a. determining a distance between candidates of a search space at each aggregation level; b. revising the determined distance using a bias parameter, which is based upon a carrier indicator n_{CI}, wherein the n_{CI} indicates respective carriers among N_{CI} carriers that can be scheduled concurrently, and N_{CI} represents total number of carriers that can be scheduled concurrently; and c. determining positions, of the candidates of the search space at each aggregation level, in allocated ECCEs at least according to the revised distance.

According to a third aspect, there is proposed an apparatus for determining an ECCE user equipment specific search space of an EPDCCH for cross carrier scheduling, the apparatus including: a first determining unit configured to determine distance between candidates of a search space at each aggregation level at least according to total number N_{CI} of carriers that can be scheduled concurrently and a carrier indicator n_{CI}, wherein the carrier indicator n_{CI} indicates respective carriers among the N_{CI} carriers that can be scheduled concurrently; and a second determining unit configured to determine positions, of the candidates of the search space at each aggregation level, in allocated ECCEs at least according to the determined distance.

According to a fourth aspect, there is proposed an apparatus for determining an ECCE user equipment specific search space of an EPDCCH for cross carrier scheduling, the apparatus including: a third determining unit configured to determine distance between candidates of a search space at each aggregation level; a revising unit configured to revise the determined distance using a bias parameter, which is based upon a carrier indicator n_{CI}, wherein the n_{CI} indicates respective carriers among N_{CI} carriers that can be scheduled concurrently, and N_{CI} represents total number of carriers that can be scheduled concurrently; and a fourth determining unit configured to determine positions, of the candidates of the search space at each aggregation level, in allocated ECCEs at least according to the revised distance.

With the invention, the framework of a search space derived in RANI #71 is maintained for localized transmission, and control information over a carrier corresponding to data over different carriers can be spaced apart and use different candidates, that is, use different ECCEs. Thus the control information corresponding to the data carried over the different carriers can be spaced apart over actually used frequency band resources. Thereby, the interference resulting from the scheduling of the different carriers for the same user equipment is avoided.

### BRIEF DESCRIPTION OF DRAWINGS

Other features, objects and advantages of the invention will become more apparent upon review of the following detailed description of non-limiting particular embodiments taken in connection with the drawings in which:

FIG. 1 illustrates a flow chart of a method according to a particular embodiment of the invention; and

FIG. 2 illustrates a flow chart of a method according to another particular embodiment of the invention.

### DETAILED DESCRIPTION OF EMBODIMENTS

Formula 1 given in the background of the invention will be firstly described here by way of an example. Now the respective parameters in Formula 1 above are assumed as follows: a total number N_{ECCE,k} of available ECCEs configured in a k-th sub-frame for a user equipment is 32 (where sequence numbers for these available ECCEs can be 0, 1, . . . , 31); Yₖ is 1; L=1, 2, 4, 8; and Mₛₑₜ^{(L)} corresponding to these aggregation levels L are 4, 4, 2, 2 respectively. Then positions of candidates of ECCEs at each aggregation level can be derived in Formula 1 as follows:

With L=1, positions of candidates of ECCEs can be derived as {1}, {9}, {17}, {25}.

Particularly, in the situation where L=1, i=0. And since Mₛₑₜ^{(L)}=4, m takes the values of 0, 1, 2, 3. Thus N_{ECCE,k}=32, Yₖ=1, L=1, Mₛₑₜ^{(L)}=4 and m=0 are substituted into Formula 1, and a position of a candidate can be derived as {1}, that is, the candidate is positioned in an ECCE numbered 1 among the allocated ECCEs. Next N_{ECCE,k}=32, Yₖ=1, L=1, Mₛₑₜ^{(L)}=4 and m=1 are substituted into Formula 1, and a position of a candidate can be derived as {9}, that is, the candidate is positioned in an ECCE numbered 9 among the allocated ECCEs. This is repeated to derive the positions of other two candidates as {17}, {25}, that is, the candidates are positioned in ECCEs numbered 17 and 25 among the allocated ECCEs.

For L=2, positions of candidates for ECCEs can be derived as {2,3}, {10,11}, {18,19}, {26,27}, that is, the candidates are positioned in ECCEs numbered 2, 3; 10, 11; 18, 19; 26, 27 among the allocated ECCEs.

Particularly, in the situation where L=2, i=0, 1. And since Mₛₑₜ^{(L)}=4, m takes the values of 0, 1, 2, 3. Thus N_{ECCE,k}=32, Yₖ=1, L=1, Mₛₑₜ^{(L)}=4, m=0 and i=0 are substituted into Formula 1, and a position of a candidate can be derived as {1}. Next N_{ECCE,k}=32, Yₖ=1, L=1, Mₛₑₜ^{(L)}=4, m=0 and i=1 (that is, i is changed to 1 while keeping the values of the other parameters unchanged) are substituted into Formula 1, and a position of a candidate can be derived as {3}. Thus the positions of the candidates with m=0 are derived as {2, 3}. Next the value of m is changed, that is, m is changed to 1, 2, 3 respectively, and finally the positions of other candidates with the respective values of m can be derived similarly as {10,11}, {18,19}, {26,27}, where the number of positions in a pair of brackets reflects an aggregation level, which is 2 here.

With L=4, i takes the values of 0, 1, 2, 3, and with Mₛₑₜ^{(L)}=2, m takes the values of 0 and 1. Thus the positions of candidates for ECCEs can be derived similarly as {4, 5, 6, 7}, {20, 21, 22, 23}.

With L=8, i takes the values of 0, 1, 2, 3, . . . , 7, and with Mₛₑₜ^{(L)}=2, m takes the values of 0 and 1. Thus the positions of candidates for ECCEs can be derived similarly as {8, 9, 10, 11, 12, 13, 14, 15}, {24, 25, 26, 27, 28, 29, 30, 31}.

As can be apparent from the foregoing derivation, the ECCEs of all the derived candidates can be distributed uniformly in allocated Physical Resource Block (PRB) pairs.

Then, the Formula 3, to which the carrier indicator n_{CI} is introduced, in the background of the invention will be reviewed, compared with Formula 1, original m has been replaced with m+Mₛₑₜ^{(L)} n_{cl} in Formula 3. It is assumed here that the total number NI_{CI} of carriers that can be scheduled concurrently is 2, since n_{CI} is 0, 1, . . . , N_{CI}, n_{CI} is 0 and 1 here. The values of the other parameters in Formula 3 are identical with those of the respective parameters in Formula 1.

Derivation will be performed in Formula 3 with n_{CI} equal to 0 and 1 respectively (a particular derivation process is similar to that in Formula 1 above, and a detailed description thereof will be omitted here), and it is derived out that for the two situation, in which n_{CI} equals to 0 and 1, the positions of candidates for ECCEs are same:

For L=1, positions of candidates for ECCEs can be derived as {1}, {9}, {17}, {25}.

For L=2, positions of candidates for ECCEs can be derived as {2,3}, {10,11}, {18,19}, {26,27}.

For L=3, positions of candidates for ECCEs can be derived as {4, 5, 6, 7}, {20, 21, 22, 23}.

For L=4, positions of candidates for ECCEs can be derived as {8, 9, 10, 11, 12, 13, 14,15}, {24, 25, 26, 27, 28, 29, 30, 31}.

Thus with the solution in Formula 3 in the background of the invention, ECCEs occupied by control information corresponding to different carriers carrying data will overlap with each other in the situation of cross carrier scheduling. Thus the positions of different candidate ECCEs can not be distinguished for the different carriers carrying the data, thus resulting in collision.

A solution of the invention will be described below in details with reference to the drawings.

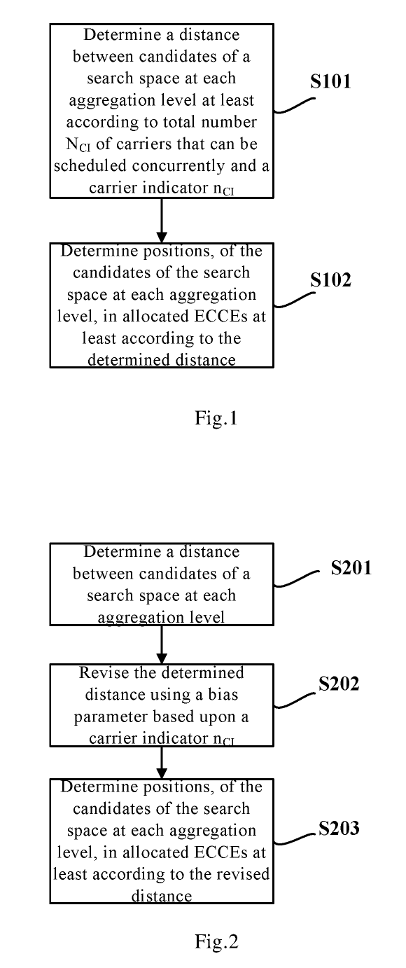

FIG. 1 illustrates a flow chart of a method according to a particular (c) embodiment of the invention. In the step S101, a distance between candidates of a search space at each aggregation level is determined at least according to total number N_{CI} of carriers that can be scheduled concurrently and a carrier indicator n_{CI}, where the carrier indicator n_{CI} indicates respective carriers among the N_{CI} carriers that can be scheduled concurrently. Particularly, for example, the distance can be determined in the formula of:

$${P}_{L} = ⌊ \frac{( m \cdot {N}_{CI} + {n}_{CI} ) \cdot {N}_{ECCE , k}}{L \cdot {M}_{set}^{( L )} \cdot {N}_{CI}} ⌋ , \qquad ( Formula 5 )$$

Where L represents the aggregation level, and P_{L} represents a distance between candidates at the L-th aggregation level, N_{ECCE,k} represents a total number of available ECCEs configured in a k-th sub-frame for a user equipment, Mₛₑₜ^{(L)} represents a total number of candidates of the search space at the L-th aggregation level, and m=0, . . . , Mₛₑₜ^{(L)}−1 represents a sequence number among the Mₛₑₜ^{(L)} candidates.

Next in the step S102, positions, of the candidates of the search space at each aggregation level, in allocated ECCEs are determined at least according to the determined distance. Particularly, for example, the positions of the candidates of the search space at each aggregation level are determined as the search space in the formula of:

Sₖ^{(L)}=L·{(Yₖ+P_{L})mod └N_{ECCE,k}/L┘}+i, (Formula 6)

Where:

$${P}_{L} = ⌊ \frac{( m \cdot {N}_{CI} + {n}_{CI} ) \cdot {N}_{ECCE , k}}{L \cdot {M}_{set}^{( L )} \cdot {N}_{CI}} ⌋ ,$$

Sₖ^{(L)} represents the search space at the L-th aggregation level, Yₖ represents a hash function based upon the frame k and an RNTI of the user equipment, and i=0, 1, 2 . . . L−1 represents a sequence number of an ECCE at each aggregation level.

The following derivation will be performed with Formula 6 still with the respective parameters above in Formula 3. That is, the total number N_{ECCE,k} of available ECCEs configured in the k-th sub-frame for the user equipment is 32; Yₖ is 1; L=1, 2, 4, 8; Mₛₑₜ^{(L)} corresponding to these aggregation levels L are 4, 4, 2, 2 respectively; N_{CI} is 2; and n_{CI} is 0 and 1.

Firstly, in the situation n_{CI} equals to 0:

When L=1, positions of candidates of ECCEs can be derived as {1}, {9}, {17}, {25}, that is, the candidates are positioned in the ECCEs numbered 1, 9, 17 and 25 among the allocated ECCEs.

Particularly, in the situation where L=1, i=0. Since Mₛₑₜ^{(L)}=4, m takes the values of 0, 1, 2, 3. Thus N_{ECCE,k}=32 (where sequence numbers for these available ECCEs can be 0, 1, . . . , 31), Yₖ=1, L=1, Mₛₑₜ^{(L)}=4, m=1 and N_{CI}=2 are substituted into Formula 6, and a position of a candidate can be derived as {1}. Next N_{ECCE,k}=32, Yₖ=1, L=1, Mₛₑₜ^{(L)}=4, m=1 and N_{CI}=2 are substituted into Formula 6, and a position of a candidate can be derived as {9}. Similarly, m=2 and 3 are substituted into Formula 6 while keeping the other parameters unchanged to derive the positions of candidates for other two ECCEs as {17}, {25}.

When L=2, positions of candidates of ECCEs can be derived as {2, 3}, {10,11}, {18,19}, {26,27}, that is, the candidates are positioned in the ECCEs numbered 2, 3; 10, 11; 18, 19; 26, 27 among the allocated ECCEs.

Particularly, in the situation where L=2, i=0, 1. And since Mₛₑₜ^{(L)}=4, m takes the values of 0, 1, 2, 3. Thus N_{ECCE,k}=32, Yₖ=1, L=1, Mₛₑₜ^{(L)}=4, m=0 and i=0 are substituted into Formula 6, and a position of a candidate can be derived as {2}. Next N_{ECCE,k}=32, Yₖ=1, L=1, Mₛₑₜ^{(L)}=4, m=0 and i=1 are substituted into Formula 6 (that is, i is changed to 1 while keeping the values of the other parameters unchanged), and a position of a candidate can be derived as {3}. Thus the positions of the candidates with m=0 are derived as {2, 3}. Next the value of m is changed, that is, m is changed to 1, 2, 3 respectively, and finally the positions of candidates for other candidates for the respective values of m can be derived similarly as {10,11}, {18,19}, {26,27}.

For L=4, i takes the values of 0, 1, 2, 3, and with Mₛₑₜ^{(L)}=2, m takes the values of 0 and 1. Thus the positions of candidates for ECCEs can be derived similarly as {4, 5, 6 7}, {20, 21, 22, 23}, that is, the candidates are positioned in the ECCEs numbered 4, 5, 6, 7; 20, 21, 22, 23 among the allocated ECCEs.

For L=8, i takes the values of 0, 1, 2, 3, . . . , 7, and with Nrₑ), =2, m takes the values of 0 and 1. Thus the positions of candidates for ECCEs can be derived similarly as {8, 9, 10, 11, 12, 13, 14, 15}, {24, 25, 26, 27, 28, 29, 30, 31}, that is, the candidates are positioned in the ECCEs numbered 8, 9, 10, 11, 12, 13, 14, 15; 24, 25, 26, 27, 28, 29, 30, 31 among the allocated ECCEs.

Secondly, in the situation n_{CI} equals to 1:

Similar derivation will be performed in Formula 6 as follows:

When L=1, the positions of candidates for ECCEs are {5}, {13}, {21}, {29}.

When L=2, the positions of candidates for ECCEs are {6, 7}, {14, 15}, {22, 23}, {30, 31}.

When L=4, the positions of candidates for ECCEs are {12, 13, 14, 15}, {28, 29, 30, 31}.

When L=8, the positions of candidates for ECCEs are {16, 17, 18, 19, 20, 21, 22, 23}, {0, 1, 2, 3, 4, 5, 6, 7}.

As can be apparent from the derivation results above, the positions of the candidates for the ECCEs in use will vary with a different carrier indicator n_{CI}. This means that even if control information for different carriers carrying data is carried over the same carrier (i.e., cross carrier scheduling is performed), the control information corresponding to the data carried over the different carriers can be spaced apart over the ECCEs, i.e. over actually used frequency band resources. Thus collision with different cross carrier scheduling of an EPDCCH for the same user equipment can be alleviated. Also in this embodiment, all the derived candidate ECCEs at the respective aggregation levels can be distributed uniformly in allocated Physical Resource Block (PRB) pairs.

Another embodiment of the invention will be described now with reference to FIG. 2. As illustrated in FIG. 2, in the step S201, a distance between candidates of a search space at each aggregation level is determined. For example, the distance can be determined in the formula of:

$${P}_{L} = ⌊ \frac{m \cdot {N}_{ECCE , k}}{L \cdot {M}_{set}^{( L )}} ⌋ , \qquad ( Formula 7 )$$

That is, the distance between the candidates of the search space at each aggregation level is determined here still in the corresponding section of Formula 1.

Next in the step S202, the determined distance is revised using a bias parameter, which is based upon a carrier indicator n_{CI}, wherein the n_{CI} indicates respective carriers among N_{CI} carriers that can be scheduled concurrently, and N_{CI} represents total number of carriers that can be scheduled concurrently. Particularly, the bias parameter is the carrier indicator n_{CI}, and the determined distance can be revised by adding the carrier indicator n_{CI} to the determined distance. Alternatively or additionally, the determined distance can be revised in combination with an integer multiple of the aggregation level L, i.e., k*L.

In the step S203, positions, of the candidates of the search space at each aggregation level, in allocated ECCEs are determined at least according to the revised distance. Particularly, the positions of the candidates of the search space at each aggregation level, i.e. search spance, can be determined in the formula of:

Sₖ^{(L)}=L·{(Yₖ+P_{L}+n_{CI})mod └N_{ECCE,k}/L┘}+i, (Formula 8)

Where:

$${P}_{L} = ⌊ \frac{m \cdot {N}_{ECCE , k}}{L \cdot {M}_{set}^{( L )}} ⌋ ,$$

Sₖ^{(L)} represents the search space at the L-th aggregation level, Yₖ represents a hash function based upon a frame k and an RNTI of a user equipment, and i=0, 1, 2 . . . L−1 represents a sequence number of an ECCE at each aggregation level.

The following derivation will be performed in Formula 8 still with the ix) respective parameters above in Formula 3 and Formula 6. That is, the total number N_{ECCE,k} of available ECCEs configured in the k-th sub-frame for the user equipment is 32; Yₖ is 1; L=1, 2, 4, 8; Mₛₑₜ^{(L)} corresponding to these aggregation levels L are 4, 4, 2, 2 respectively; N_{CI} is 2; and n_{CI} is 0 and 1.

Firstly, for the situation in which n_{CI} equals to 0:

Derivation similar to Formula 6 above can be performed in Formula 8 as follows:

When L=1, the positions of candidates are {1}, {9}, {17}, {25}.

When L=2, the positions of candidates are {2, 3}, {10, 11}, {18,19}, {26,27}.

When L=4, the positions of candidates are {4, 5, 6 7}, {20, 21, 22, 23}.

When L=8, the positions of candidates are {8, 9, 10, 11, 12, 13, 14,15}, {24, 25, 26, 27, 28, 29, 30, 31}.

And for the situation in which n_{CI} equals to 1:

When L=1, the positions of candidates are {2}, {10}, {18}, {26}.

When L=2, the positions of candidates are {4, 5}, {12, 13}, {20, 21}, {28, 29}.

When L=4, the positions of candidates are {8, 9, 10, 11}, {24, 25, 26, 27}.

When L=8, the positions of candidates are {16, 17, 18, 19, 20, 21, 22, 23}, {0, 1, 2, 3, 4, 5, 6, 7}.

Alike, as can be apparent from the derivation results above, similarly to the previous embodiment, in this embodiment, collision with different cross carrier scheduling of an EPDCCH for the same user equipment can be alleviated, and all the derived candidate ECCEs at the respective aggregation levels can be distributed uniformly in the allocated Physical Resource Block (PRB) pairs.

Moreover, the two embodiments above can be practiced at the base station side and the user equipment side. In the first embodiment, the base station needs to notify the user equipment of both the total number N_{CI} of carriers that can be scheduled concurrently and the carrier indictor n_{CI}, and the base station and the user equipment determine an ECCE user equipment specific search space under localized transmission based upon the same algorithm. In the second embodiment, the base station only needs to notify the user equipment of the carrier indictor n_{CI}, and then the base station and the user equipment determine an ECCE user equipment specific search space under localized transmission based upon the same algorithm.

For those skilled in the art, apparently the invention will not be limited to the details of the exemplary embodiments above but can be practiced in other particular forms without departing from the spirit or essence of the invention. Stated otherwise, those skilled in the art can change the positions and derivations of the respective parameters for a similar effect based upon the embodiments of the invention.

Thus the embodiments are merely exemplary but not limiting in any way, and the scope of the invention shall be defined by the appended claims but not by the foregoing description, so all the variations without departing from the spirit of the claims shall fall into the scope of invention. Any reference numerals in the claims shall not be construed as limiting the claims in question. Moreover apparently the term “comprise” will not preclude another element(s) or step(s) which is (are) listed in the other claim(s) or the description, and a singular will not preclude a plural. A plurality of elements or devices stated in a system claim can alternatively be embodied as the same element or device in hardware or software. The terms “first”, “second”, etc., are merely intended to designate a name but not to suggest any specific order.

1. A method of determining an ECCE user equipment specific search space of an EPDCCH for cross carrier scheduling, the method comprising:
determining a distance between candidates of a search space at each aggregation level at least according to total number N_{CI} of carriers that can be scheduled concurrently and a carrier indicator n_{CI}, wherein the carrier indicator n_{CI} indicates respective carriers among the N_{CI} carriers that can be scheduled concurrently; and
determining positions, of the candidates of the search space at each aggregation level, in allocated ECCEs at least according to the determined distance.

2. The method according to claim 1, wherein the determining a distance comprises:
determining the distance between the candidates of the search space at each aggregation level according to Mₛₑₜ^{(L)} representing total number of candidates of a search space at a L-th aggregation level, a sequence number m, a total number N_{ECCE,k} of available ECCEs configured in a k-th sub-frame for the user equipment, the total number N_{CI} of carriers that can be scheduled concurrently and the carrier indicator n_{CI}, wherein the sequence number m=0, . . . , Mₛₑₜ^{(L)}−1 represents a sequence number among the Mₛₑₜ^{(L)} candidates.

3. The method according to claim 2, wherein in the determining a distance, the distance is determined in the formula of:
$${P}_{L} = ⌊ \frac{( m \cdot {N}_{CI} + {n}_{CI} ) \cdot {N}_{ECCE , k}}{L \cdot {M}_{set}^{( L )} \cdot {N}_{CI}} ⌋ ,$$
wherein L represents the aggregation level, and P_{L} represents a distance between candidates at the L-th aggregation level.

4. The method according to claim 3, wherein in the determining positions, the positions of the candidates of the search space at each aggregation level are determined in the formula of:
Sₖ^{(L)}=L·{(Yₖ+P_{L})mod └N_{ECCE,k}/L┘}+i,
wherein Sₖ^{(L)} represents the search space at the L-th aggregation level, Yₖ represents a hash function based upon a frame k and an RNTI of the user equipment, and i=0, 1, 2 . . . L−1 represents a sequence number of an ECCE at each aggregation level.

5. The method according to claim 1, wherein the method is performed by a base station or the user equipment.

6. A method of determining an ECCE user equipment specific search space of an EPDCCH for cross carrier scheduling, the method comprising:
determining a distance between candidates of a search space at each aggregation level;
revising the determined distance using a bias parameter, which is based upon a carrier indicator n_{CI} wherein the n_{CI} indicates respective carriers among N_{CI} carriers that can be scheduled concurrently, and N_{CI} represents total number of carriers that can be scheduled concurrently; and
determining positions, of the candidates of the search space at each aggregation level, in allocated ECCEs at least according to the revised distance.

7. The method according to claim 6, wherein in the determining a distance, the distance is determined in the formula of:
$${P}_{L} = ⌊ \frac{m \cdot {N}_{ECCE , k}}{L \cdot {M}_{set}^{( L )}} ⌋ ,$$
wherein L represents the aggregation level, P_{L} represents a distance between candidates at the L-th aggregation level, N_{ECCE,k} represents total number of available ECCEs configured in a k-th sub-frame for the user equipment, Mₛₑₜ^{(L)} represents a total number of candidates of the search space at the L-th aggregation level, and m=0, . . . , Mₛₑₜ^{(L)}−1 represents a sequence number among the Mₛₑₜ^{(L)} candidates.

8. The method according to claim 6, wherein in the revising, the determined distance is revised by adding the bias parameter to the determined distance, and wherein the bias parameter is the carrier indicator n_{CI}.

9. The method according to claim 8, wherein in the determining positions, the positions of the candidates of the search space at each aggregation level are determined in the formula of:
Sₖ^{(L)}=L·{(Yₖ+P_{L})mod └N_{ECCE,k}/L┘}+i,
wherein Sₖ^{(L)} represents the search space at the L-th aggregation level, Yₖ represents a hash function based upon a frame k and an RNTI of the user equipment, and 1=0, 1, 2 . . . L−1 represents a sequence number of an ECCE at each aggregation level.

10. The method according to claim 6, wherein the method is performed by a base station or the user equipment.

11. An apparatus for determining an ECCE user equipment specific search space of an EPDCCH for cross carrier scheduling, the apparatus comprising:
a first determining unit configured to determine a distance between candidates of a search space at each aggregation level at least according to total number N_{CI} of carriers that can be scheduled concurrently and a carrier indicator n_{CI}, wherein the carrier indicator n_{CI} indicates respective carriers among the N_{CI} carriers that can be scheduled concurrently; and
a second determining unit configured to determine positions, of the candidates of the search space at each aggregation level, in allocated ECCEs at least according to the determined distance.

12. An apparatus for determining an ECCE user equipment specific search space of an EPDCCH for cross carrier scheduling, the apparatus comprising:
a third determining unit configured to determine a distance between candidates of a search space at each aggregation level;
a revising unit configured to revise the determined distance using a bias parameter, which is based upon a carrier indicator n_{CI}, wherein the n_{CI} indicates respective carriers among N_{CI} carriers that can be scheduled concurrently, and N_{CI} represents total number of carriers that can be scheduled concurrently; and
a fourth determining unit configured to determine positions, of the candidates of the search space at each aggregation level, in allocated ECCEs at least according to the revised distance.
